(19) United States
(12) Patent Application Publication
(10) Pub. No.: US 2025/0030613 A1
(43) Pub. Date: Jan. 23, 2025

(54) PERFORMANCE SUPERVISION AND/OR FAILURE DETECTION OF MACHINE LEARNING MODEL

(71) Applicant: Nokia Technologies Oy, Espoo (FI)

(72) Inventors: Salah Eddine HAJRI, Nozay (FR); Rana AHMED SALEM, Stuttgart (DE); Keeth Saliva Jayasinghe LADDU, Espoo (FI); Mihai ENESCU, Espoo (FI); Frederick VOOK, Naperville, IL (US); William HILLERY, Naperville, IL (US); Filippo TOSATO, Massy (FR)

(21) Appl. No.: 18/713,061

(22) PCT Filed: Dec. 3, 2021
(86) PCT No.: PCT/EP2021/084136

§ 371 Date: May 23, 2024

(51) Int. Cl. H04L 41/16; G06N 20/00

(52) U.S. Cl. CPC H04L 41/16; G06N 20/00

(57) ABSTRACT

A first apparatus, comprising at least one processor, and at least one memory storing instructions, the at least one memory and the instructions configured to, with the at least one processor, cause the first apparatus to transmit configuration information to a second apparatus for performance supervision and/or failure detection of at least one machine learning model, wherein the at least one machine learning model is used by at least one of the first apparatus and the second apparatus.

### FIELD OF THE DISCLOSURE

Various example embodiments relate to an apparatus comprising at least one processor.

Further embodiments relate to a method of operating related to such apparatus.

### BACKGROUND

Wireless communications systems may e.g. be used for wireless exchange of information between two or more entities, e.g. comprising one or more terminal devices, e.g. user equipment, and one or more network devices such as e.g. base stations.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some embodiments relate to a first apparatus, comprising at least one processor, and at least one memory storing instructions, the at least one memory and the instructions configured to, with the at least one processor, cause the first apparatus to transmit configuration information to a second apparatus for performance supervision and/or failure detection of at least one machine learning model, wherein the at least one machine learning model is used by at least one of the first apparatus and the second apparatus.

In some embodiments, this may facilitate operation of the at least one machine learning model and/or a coordination of the first apparatus, e.g. with the second apparatus, regarding the operation of the at least one machine learning model.

In some embodiments, the at least one machine learning model can be used temporarily, for example meaning that it can, at least temporarily, be superseded by other types of operation model, such as by another type of machine learning model, by a newly/previously-trained model of the same type, or by a parametric model.

In some embodiments, the first apparatus may be an apparatus for a wireless communications system.

In some embodiments, the first apparatus or its functionality, respectively, may be provided in a network device, for example network node, of the communications system, for example in a base station, e.g. an Evolved NodeB (eNB), a next-generation NodeB (gNB), or in a radio access point, e.g. a Wifi access point.

In some embodiments, the first apparatus or its functionality, respectively, may be provided in a terminal device, for example a terminal device for a wireless communications system. In some embodiments, the terminal device may comprise at least one of: a) a smartphone, b) a tablet computer, c) a laptop or personal computer, d) an IoT (Internet of Things) device, e) a wearable device such as e.g. a smart watch or virtual reality glasses, and f) a vehicle, for example a car, a truck, an aircraft, for example an unmanned aerial vehicle, e.g. a drone. In some embodiments, the first apparatus according to the embodiments or its functionality, respectively, may be used for or within wireless communications systems, e.g. networks, based on or at least partially adhering to third generation partnership project, 3GPP, radio standards such as 4G/Long-Term Evolution (fourth generation) 5G/New Radio (fifth generation), beyond 5G, e.g., 6G, or other radio access technology such as Wifi.

In some embodiments, the first apparatus is a base station, e.g. for a wireless communications system, and the second apparatus is a terminal device, e.g. for the wireless communications system.

In some embodiments, the first apparatus is a terminal device and the second apparatus is a base station.

In some embodiments, the first apparatus is a terminal device and the second apparatus is a terminal device.

In some embodiments, the configuration information comprises at least one of: a) information related to at least one resource for performance supervision of the at least one machine learning model, b) information related to at least one signal for performance supervision of the at least one machine learning model, c) information related to at least one performance metric for failure detection of the at least one machine learning model, d) information related to a temporal behavior for performance supervision and/or failure detection of the at least one machine learning model, e) information related to parameters for failure detection of the at least one machine learning model, and f) information related to rules for failure detection of the at least one machine learning model.

In some embodiments, the information related to at least one resource for performance supervision of the at least one machine learning model and/or the information related to at least one signal for performance supervision of the at least one machine learning model characterizes at least one of: a) a downlink reference signal, DL RS, b) a dedicated signal, c) a resource element associated with a data signal.

In some embodiments, the information related to at least one performance metric for failure detection of the at least one machine learning model may characterize at least one of: a) a mean square error (MSE) of a variable output by the at least one machine learning model, b) a mean absolute error (MAE) of a variable output by the least one machine learning model, c) a recall, for example characterized by the equation

$$Recall = \frac{True Positive}{True Positive + False Negative} ,$$

wherein “True Positive” characterizes a number of true positives, wherein “False Negative” characterizes a number of false negatives, d) a precision, for example characterized by the equation

$$Precision = \frac{True Positive}{True Positive + False Positive ,}$$

wherein “False Positive” characterizes a number of false positives, e) an accuracy, for example characterized by the equation

$$Accuracy = \frac{\# of correct predictions}{total \# of predictions} ,$$

wherein “# of correct predictions” characterizes a number of correct predictions, wherein “total # of predictions” characterizes a total number of predictions, and f) an F1-score, for example characterized by the equation

$${F}_{1} score = \frac{2 \times Precision \cdot Recall}{Precision + Recall} ,$$

which is e.g. based on the values “Precision” and “Recall” of the exemplary performance metrics of items c) and d) mentioned above.

In some embodiments, statistical quantities derivable from the abovementioned exemplary metrics may be also used, for example as model failure detection criteria, e.g. at least one of: a mean value, a standard deviation value, a Q-tiles, a minimum value, a maximum value.

In some embodiments, a combination of relevant metrics, e.g. of the exemplary abovementioned metrics, and their usage, for example for a given machine learning model, may be configured, for example depending on a traffic type. In some embodiments, the combination may be modified dynamically, e.g. during operation of the network device and/or the terminal device, e.g. via MAC (medium access control)-level (e.g., layer 2) or RRC-level signaling, or any other signaling means.

In some embodiments, the information related to a temporal behavior for performance supervision with respect to the at least one machine learning model may characterize at least one of: periodic, aperiodic, semi-persistent.

In some embodiments, the information related to parameters for failure detection and/or rules for failure detection with respect to the at least one machine learning model may for example indicate one or more conditions that need to be fulfilled before a model failure is declared. In some embodiments, these conditions may include at least one of: a) a failure detection threshold for a given metric or thresholds for multiple metrics, b) an allowed number of failure instances, e.g. before the model failure will be declared, and c) an allowed time between the detection of a first failure instance and a failure indication, which, in some embodiments, may e.g. be sent to higher layers.

In some embodiments, the configuration information may be used, for example by the network device and/or by the terminal device, for model supervision and/or failure detection with respect to the at least one machine learning model.

In some embodiments, the at least one machine learning model is used by the first apparatus, wherein the instructions, when executed by the at least one processor, cause the first apparatus to receive a failure indication from the second apparatus indicative of a failure of the at least one machine learning model detected in accordance with the configuration information, and responsive to the failure indication, to transmit a model recovery indication to the second apparatus.

In some embodiments, the failure indication comprises a fallback solution, e.g. as proposed for example by the second apparatus, for recovering the failure of the at least one machine learning model, the proposed fallback solution for example comprising another model type, or a prior training state of the machine learning model.

In some embodiments, the model recovery indication comprises at least one of: a) an indication whether a failure recovery was successful, b) at least one update of the at least one machine learning model, c) configuration parameters associated with the failure recovery, and d) a time offset characterizing a start of operation based on a recovered model obtained by the failure recovery.

In some embodiments, the at least one machine learning model may be used for at least one of the following aspects: a) prediction, e.g. for predicting data associated with an operation of at least one of the first apparatus, the second apparatus, and, optionally, a further device, for example a further terminal device, for example prediction of channel quality indicator(s), CQI, and/or channel state 30 information, CSI, b) compression, e.g. for compressing data associated with an operation of at least one of the first apparatus, the second apparatus, and, optionally, a further device (e.g., a further terminal device), for example CSI compression, and c) prediction, e.g. for predicting data associated with an operation of at least one of the first apparatus, the second apparatus, and, optionally, a further device (e.g., a further terminal device), for example prediction for beam tracking, or for Modulation and Coding Scheme (MCS) selection, etc.

In some embodiments, the instructions, when executed by the at least one processor, cause the first apparatus to transmit the configuration information in a radio resource control, RRC, message, for example within an RRC (re-)configuration message or an RRC UE assistance information message according to some accepted standard.

In some embodiments, the first apparatus may configure the second apparatus with one or more configurations, e.g. using the configuration information, e.g. transmitted via a RRC message, wherein at least one of the configurations may indicate a type of the at least one machine learning model (for example prediction, classification or compression model usage). In other words, in some embodiments, the configuration information may comprise the type or information characterizing the type of the at least one machine learning model.

In some embodiments, the configuration information may also be used to indicate a specific configuration, i.e. type of operation, for example specifying that learning is enabled for a given functionality, measurement or CSI quantity, and its corresponding parameters.

In some embodiments, the instructions, when executed by the at least one processor, cause the first apparatus to at least temporarily perform at least one of: a) one or more operations based on the at least one machine learning model, for example processing or evaluating the machine learning model (for example, inference), b) monitoring a performance of the at least one machine learning model, c) detecting a failure of the at least one machine learning model, d) indicating a failure of the at least one machine learning model, and e) initiating a recovery of the at least one machine learning model.

In some embodiments, the at least one machine learning model may be provided a) at the first apparatus, for example, in case of the first apparatus comprising or representing a network device, at a network side, e.g. for or within the network device, b) at the second apparatus, for example, in case of the second apparatus comprising or representing a terminal device, at a terminal device side, e.g. for or within the terminal device, or c) both at the first apparatus and at the second apparatus, for example both at a network side and at a terminal device side.

In other words, in some embodiments, the at least one machine learning model may be provided a) at a network side, e.g. for or within the network device, b) at a terminal device side, e.g. for or within the terminal device, or c) both at the network side and at the terminal device side.

In some embodiments, wherein the first apparatus comprises or represents a first terminal device and wherein the second apparatus comprises or represents a second terminal device, the at least one machine learning model may be provided a) at the first terminal device, b) at the second terminal device, or c) both at the first terminal device and at the second terminal device.

In some embodiments, the instructions, when executed by the at least one processor, cause the first apparatus to transmit a failure indication indicating a failure of the at least one machine learning model to the second apparatus.

In view of this, in some embodiments, signaling, for example for model failure detection and/or recovery, may depend on where the at least one machine learning model is being applied and, for example, on which side, i.e. first apparatus or second apparatus, for example terminal device side or network device side, is initiating a model failure procedure. Some exemplary operational scenarios according to some embodiments will be explained further below.

In some embodiments, the instructions, when executed by the at least one processor, cause the first apparatus to perform at least one of: a) detecting a failure of the at least one machine learning model, b) recovering the failure of the at least one machine learning model, c) transmitting to the second apparatus a model recovery indication comprising at least one of: c1) an indication whether a failure recovery was successful, c2) at least one update of the machine learning model, c3) configuration parameters associated with the failure recovery, c4) a time offset characterizing a start of operations based on a recovered model obtained by the failure recovery.

Some embodiments relate to a method comprising: transmitting, by a first apparatus, configuration information to a second apparatus for performance supervision and/or failure detection of at least one machine learning model, wherein the at least one machine learning model is used by at least one of the first apparatus and the second apparatus.

Some embodiments relate to a first apparatus comprising means for transmitting configuration information to a second apparatus for performance supervision and/or failure detection of at least one machine learning model, wherein the at least one machine learning model is used by at least one of the first apparatus and the second apparatus. In some embodiments, the means for transmitting the configuration information may e.g. comprise at least one processor, and at least one memory storing instructions, the at least one memory and the instructions configured to, with the at least one processor, perform the step of transmitting the configuration information.

Some embodiments relate to a second apparatus, comprising at least one processor, and at least one memory storing instructions, the at least one memory and the instructions configured to, with the at least one processor, cause the second apparatus to receive configuration information from a first apparatus for performance supervision and/or failure detection of at least one machine learning model, wherein the at least one machine learning model is used by at least one of the first apparatus and the second apparatus.

In some embodiments, the second apparatus may be an apparatus for a wireless communications system.

In some embodiments, the second apparatus or its functionality, respectively, may be provided in a terminal device, for example user equipment (UE), of the communications system. In some embodiments, the terminal device may comprise at least one of: a) a smartphone, b) a tablet computer, c) a laptop or a personal computer, d) an IoT (Internet of Things) device, e) a wearable device such as e.g. a smart watch or virtual reality glasses, f) a vehicle, for example a car, a truck, an aircraft, for example an unmanned aerial vehicle, e.g. a drone.

In some embodiments, the second apparatus or its functionality, respectively, may be used for or within wireless communications systems, e.g. networks, based on or at least partially adhering to third generation partnership project, 3GPP, radio standards such as 5G (fifth generation), beyond 5G, e.g., 6G, or other radio access technology such as Wifi.

In some embodiments, an operation of at least one of the second apparatus and the at least one machine learning model may be performed based on the configuration information, i.e. the configuration information received from the first apparatus.

In some embodiments, the configuration information comprises at least one of: a) information related to at least one resource for performance supervision of the at least one machine learning model, b) information related to at least one signal for performance supervision of the at least one machine learning model, c) information related to at least one performance metric for failure detection of the at least one machine learning model, d) information related to a temporal behavior for performance supervision and/or failure detection of the at least one machine learning model, e) information related to parameters for failure detection of the at least one machine learning model, and f) information related to rules for failure detection of the at least one machine learning model

In some embodiments, the at least one machine learning model is used by the first apparatus, and the instructions, when executed by the at least one processor, cause the second apparatus to transmit a failure indication to the first apparatus, the failure indication being indicative of a failure of the at least one machine learning model detected in accordance with the configuration information, and to receive a model recovery indication from the first apparatus responsive to the failure indication.

In some embodiments, the failure indication comprises a fallback solution, e.g. as proposed for example by the second apparatus, for recovering the failure of the at least one machine learning model, the proposed fallback solution for example comprising another model type, or a prior training state of the machine learning model.

In some embodiments, the model recovery indication comprises at least one of: a) an indication whether a failure recovery was successful, b) at least one update of the at least one machine learning model, c) configuration parameters associated with the failure recovery, and d) a time offset characterizing a start of operation based on a recovered model obtained by the failure recovery.

In some embodiments, the information related to at least one performance metric for failure detection of the at least one machine learning model may characterize at least one of: a) a mean square error (MSE) of a variable output by the at least one machine learning model, b) a mean absolute error (MAE), c) a recall, for example characterized by the equation

$$Recall = \frac{True Positive}{True Positive + False Negative} ,$$

wherein “True Positive” characterizes a number of true positives, wherein “False Negative” characterizes a number of false negatives, d) a precision, for example characterized by the equation

$$Precision = \frac{True Positive}{True Positive + False Positive} ,$$

wherein “False Positive” characterizes a number of false positives, e) an accuracy, for example characterized by the equation

$$Accuracy = \frac{\# of correct predictions}{total \# of predictions} ,$$

wherein “# of correct predictions” characterizes a number of correct predictions, wherein “total # of predictions” characterizes a total number of predictions, and f) an F1-score, for example characterized by the equation

$${F}_{1} score = \frac{2 \times Precision \cdot Recall}{Precision + Recall} ,$$

which is e.g. based on the values “Precision” and “Recall” of the exemplary performance metrics of items c) and d) mentioned above.

In some embodiments, a) the first apparatus is a base station and the second apparatus is a terminal device, or b) the first apparatus is a terminal device and the second apparatus is a base station, or c) the first apparatus is a terminal device and the second apparatus is a terminal device.

In some embodiments, the instructions, when executed by the at least one processor, cause the second apparatus to at least temporarily perform at least one of: a) one or more operations based on the at least one machine learning model, b) monitoring a performance of the at least one machine learning model, c) detecting a failure of the at least one machine learning model, d) indicating a failure of the at least one machine learning model, e) initiating a recovery of the at least one machine learning model.

In some embodiments, the instructions, when executed by the at least one processor, cause the second apparatus to perform at least one of: a) detecting a failure of the at least one machine learning model, b) recovering the failure of the at least one machine learning model, c) transmitting to the first apparatus a model recovery indication comprising at least one of: c1) an indication whether a failure recovery was successful, c2) at least one update of the machine learning model, c3) configuration parameters associated with the failure recovery, c4) a time offset characterizing a start of operations based on a recovered model obtained by the failure recovery.

In some embodiments, the second apparatus may transmit capability information, e.g. in the form of a capability report, e.g. to the first apparatus, the capability information characterizing a capability or a set of capabilities of the second apparatus with respect to the at least one machine learning model. In some embodiments, for example, the second apparatus may indicate to the first apparatus that it is capable of applying and/or initializing and/or training one or more machine learning models, for example for one or multiple features, e.g., CSI prediction, COI prediction, CSI compression, beam tracking, MCS selection, etc.

In some embodiments, at least one machine learning model used at and/or by the second apparatus may be defined by the second apparatus. In some embodiments, at least one machine learning model used at and/or by the second apparatus may be initialized by the first apparatus. In some embodiments, at least one machine learning model used at and/or by the second apparatus may be provided by the network, for example by the network device.

In some embodiments, the second apparatus may apply a learned (i.e., trained) or received model, for example in a supervised or unsupervised manner by the network. In other words, in some embodiments, the second apparatus may use a machine learning model which is trained via supervised learning, e.g. by the first apparatus, whereas in some other embodiments, the second apparatus may use a machine learning model which is trained via unsupervised learning.

Further embodiments relate to a method comprising: receiving, by a second apparatus, configuration information from a first apparatus for performance supervision and/or failure detection of at least one machine learning model, wherein the at least one machine learning model is used by at least one of the first apparatus and the second apparatus.

Further embodiments relate to a second apparatus comprising means for receiving configuration information from a first apparatus for performance supervision and/or failure detection of at least one machine learning model, wherein the at least one machine learning model is used by at least one of the first apparatus and the second apparatus. In some embodiments, the means for receiving the configuration information may e.g. comprise at least one processor, and at least one memory storing instructions, the at least one memory and the instructions configured to, with the at least one processor, perform the step of receiving the configuration information.

Further embodiments relate to a communications system comprising at least the first apparatus or the second apparatus according to the embodiments.

Further embodiments relate to a computer program comprising instructions which, when the program is executed by a computer, cause the computer to carry out the method according to the embodiments.

### BRIEF DESCRIPTION OF THE FIGURES

FIG. 1 schematically depicts a simplified block diagram according to some embodiments,

FIG. 2 schematically depicts a simplified block diagram according to some embodiments,

FIG. 3 schematically depicts a simplified block diagram according to some embodiments,

FIG. 4 schematically depicts a simplified flow chart according to some embodiments,

FIG. 5 schematically depicts a simplified block diagram according to some embodiments,

FIG. 6 schematically depicts a simplified flow chart according to some embodiments,

FIG. 7 schematically depicts a simplified block diagram according to some embodiments,

FIG. 8 schematically depicts a simplified flow chart according to some embodiments,

FIG. 9 schematically depicts a simplified flow chart according to some embodiments,

FIG. 10A schematically depicts a simplified flow chart according to some embodiments,

FIG. 10B schematically depicts a simplified flow chart according to some embodiments,

FIG. 11 schematically depicts a simplified block diagram according to some embodiments,

FIG. 12 schematically depicts a simplified flow chart according to some embodiments,

FIG. 13A schematically depicts a simplified block diagram according to some embodiments,

FIG. 13B schematically depicts a simplified signaling diagram according to some embodiments,

FIG. 14A schematically depicts a simplified block diagram according to some embodiments,

FIG. 14B schematically depicts a simplified signaling diagram according to some embodiments,

FIG. 15A schematically depicts a simplified block diagram according to some embodiments,

FIG. 15B schematically depicts a simplified signaling diagram according to some embodiments,

FIG. 16 schematically depicts a simplified block diagram according to some embodiments,

FIG. 17A schematically depicts a simplified block diagram according to some embodiments,

FIG. 17B schematically depicts a simplified signaling diagram according to some embodiments,

FIG. 18 schematically depicts a simplified block diagram according to some embodiments,

FIG. 19 schematically depicts a simplified block diagram according to some embodiments.

### DESCRIPTION OF SOME EXEMPLARY EMBODIMENTS

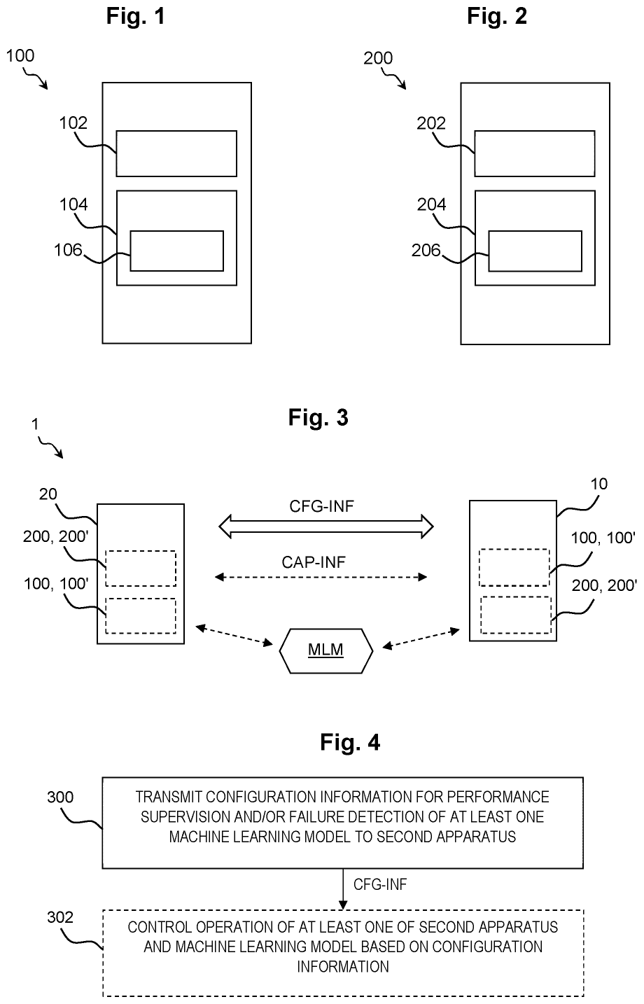

Some embodiments, see for example FIG. 1, 3, 4, relate to a first apparatus 100 (FIG. 1), comprising at least one processor 102, and at least one memory 104 storing instructions 106, the at least one memory 104 and the instructions 106 configured to, with the at least one processor 102, cause the first apparatus 100 to transmit 300 (FIG. 4) configuration information CFG-INF to a second apparatus 200 for performance supervision and/or failure detection of at least one machine learning model MLM, wherein the at least one machine learning model MLM is used by at least one of the first apparatus 100 and the second apparatus 200.

In some embodiments, this may facilitate operation of the at least one machine learning model MLM and/or a coordination of the first apparatus 100, e.g. with the second apparatus 200, regarding the operation of the at least one machine learning model MLM.

In some embodiments, the at least one machine learning model MLM can be used temporarily, for example meaning that it can, at least temporarily, be superseded by other types of operation model, such as by another type of machine learning model, by a newly-trained model of the same type, or by a parametric model (not shown). In some embodiments, the first apparatus 100 (FIG. 1) may be an apparatus for a wireless communications system 1 (FIG. 3).

In some embodiments, the first apparatus 100 or its functionality, respectively, may be provided in a network device 10, for example a network node, of the communications system 1, for example in a base station, e.g. an Evolved NodeB (eNB), a next-generation NodeB (gNB), or in a radio access point, e.g. a Wifi access point, or a part thereof, e.g. in at least one of a Distributed Unit (DU), a Central Unit (CU) and a Remote Radio Head (RRH).

In some embodiments, the first apparatus 100 or its functionality, respectively, may be provided in a terminal device 20, for example a terminal device 20 for a wireless communications system 1. In some embodiments, the terminal device 20 may comprise at least one of: a) a smartphone, b) a tablet computer, c) a laptop or a personal computer, d) an IoT (Internet of Things) device, e) a wearable device such as e.g. a smart watch or virtual reality glasses, f) a vehicle, for example a car, a truck, an aircraft, for example an unmanned aerial vehicle, e.g. a drone.

For the further explanation of exemplary embodiments, it is assumed that the first apparatus 100 is provided in the exemplary network device 10 of FIG. 3, whereas the second apparatus 200 is provided in the terminal device 20. However, as also exemplarily depicted by FIG. 3, in some embodiments, it is also possible that the terminal device 20 comprises the first apparatus 100 and that the network device 10 comprises the second apparatus 200.

In some embodiments, the first apparatus 100 according to the embodiments or its functionality, respectively, may be used for or within wireless communications systems 1, e.g. networks, based on or at least partially adhering to third generation partnership project, 3GPP, radio standards such as 4G/Long-Term Evolution (fourth generation), 5G/New Radio (fifth generation), beyond 5G, e.g., 6G, or other radio access technology, such as Wifi.

In some embodiments, the first apparatus 100 is a base station, e.g. for a wireless communications system 1, and the second apparatus 200 is a terminal device, e.g. for the wireless communications system 1.

In some embodiments, the first apparatus 100 is a terminal device and the second apparatus 200 is a base station.

In some embodiments, the first apparatus 100 is a terminal device and the second apparatus 200 is a terminal device.

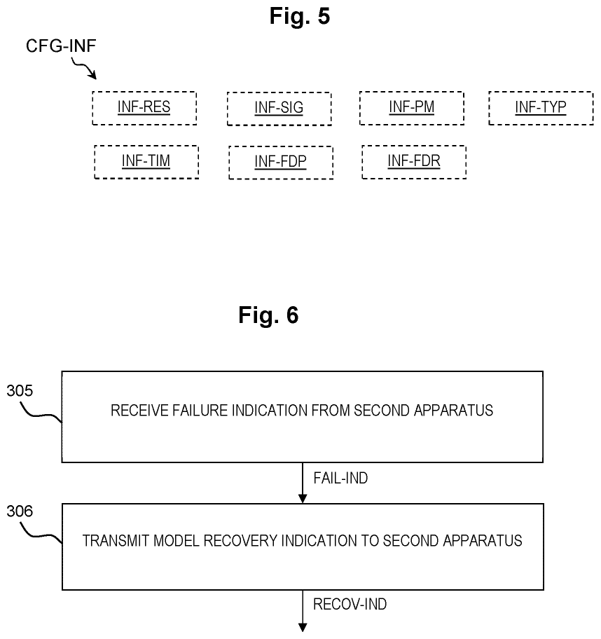

In some embodiments, FIG. 5, the configuration information CFG-INF comprises at least one of: a) information INF-RES related to at least one resource for performance supervision of the at least one machine learning model MLM, b) information INF-SIG related to at least one signal for performance supervision of the at least one machine learning model MLM, c) information INF-PM related to at least one performance metric for failure detection of the at least one machine learning model, d) information INF-TIM related to a temporal behavior for performance supervision and/or failure detection of the at least one machine learning model MLM, e) information INF-FDP related to parameters for failure detection of the at least one machine learning model MLM, and f) information INF-FDR related to rules for failure detection of the at least one machine learning model MLM.

In some embodiments, FIG. 6, the at least one machine learning model MLM is used by the first apparatus 100, wherein the instructions 106, when executed by the at least one processor 102, cause the first apparatus 100 to receive 305 a failure indication FAIL-IND from the second apparatus 200 indicative of a failure of the at least one machine learning model MLM detected in accordance with the configuration information, and responsive to the failure indication, to transmit 306 a model recovery indication RECOV-IND to the second apparatus 200. In other words, in some embodiments, the first apparatus 100 may receive a failure indication FAIL-IND from the second apparatus 200, the failure indication FAIL-IND e.g. indicating a failure of the at least one machine learning model MLM, and, upon receipt 305 of the failure indication FAIL-IND, the first apparatus 100 may transmit the model recovery indication RECOV-IND to the second apparatus 200.

In some embodiments, the failure indication FAIL-IND may indicate that something is wrong with the at least one machine learning model MLM, e.g. the at least one machine learning model MLM is behaving differently from what can be expected in a regular operation of the at least one machine learning model MLM.

In some embodiments, the failure indication FAIL-IND comprises a fallback solution, e.g. as proposed for example by the second apparatus 200, for recovering the failure of the at least one machine learning model MLM, the proposed fallback solution for example comprising another model type, or a prior training state of the machine learning model MLM.

In some embodiments, the recovery indication RECOV-IND may indicate that a recovery of the at least one machine learning model is completed, e.g. finalized.

In some embodiments, the model recovery indication RECOV-IND comprises at least one of: a) an indication whether a failure recovery was successful, b) at least one update of the at least one machine learning model MLM, c) configuration parameters associated with the failure recovery, and d) a time offset characterizing a start of operation based on a recovered model obtained by the failure recovery.

In some embodiments, the information INF-RES, INF-SIG related to at least one resource for performance supervision of the at least one machine learning model MLM and/or the information related to at least one signal for performance supervision of the at least one machine learning model MLM characterizes at least one of: a) a downlink reference signal (DL RS), b) a dedicated signal, c) resource element(s) associated with a data signal.

In some embodiments, for example in cases wherein both the first apparatus 100 and the second apparatus 200 is associated with a respective terminal device, the information INF-RES, INF-SIG related to at least one resource for performance supervision of the at least one machine learning model MLM and/or the information related to at least one signal for performance supervision of the at least one machine learning model MLM characterizes sidelink (SL) data and/or sidelink control information.

In some embodiments, resources used for model performance monitoring and/or failure detection may be reference signal resources or resource elements (RE) containing a data signal, for example in an uplink (UL) direction and/or in a downlink (DL) direction and/or in a sidelink direction, e.g. depending on the variant of the at least one machine learning model MLM used.

In some embodiments, it may be configured, and/or specified, for example by the network, e.g. network device 10, and/or by standardization, which resources should be used for a given machine learning model MLM. In some embodiments, the resources which should be used for a given machine learning model MLM may also be, for example dynamically, configured and/or updated and/or restricted and/or enhanced.

In some embodiments, for example based on the configuration, as e.g. indicated by the configuration information CFG-INF according to the embodiments, the terminal device 20 (FIG. 3) may derive at least one of: a) a time domain behavior, b) a mapping in a resource grid, c) a QCL (quasi-colocation) assumption, d) a delay-domain precoding, e) a measurement interval time restriction, etc.

In some embodiments, the information INF-PM (FIG. 5) related to at least one performance metric for failure detection of the at least one machine learning model MLM may characterize at least one of: a) a mean square error (MSE) of a variable output by the least one machine learning model MLM, b) a mean absolute error (MAE) of a variable output by the least one machine learning model MLM, c) a recall, for example characterized by the equation

$$Recall = \frac{True Positive}{True Positive + False Negative} ,$$

wherein “True Positive” characterizes a number of true positives, wherein “False Negative” characterizes a number of false negatives, d) a precision, for example characterized by the equation

$$Precision = \frac{True Positive}{True Positive + False Positive} ,$$

wherein “False Positive” characterizes a number of false positives, e) an accuracy, for example characterized by the equation

$$Accuracy = \frac{\# of correct predictions}{total \# of predictions} ,$$

wherein “# of correct predictions” characterizes a number of correct predictions, wherein “total # of predictions” characterizes a total number of predictions, and an f) F1-score, for example characterizes by the equation

$${F}_{1} score = \frac{2 \times Precision \cdot Recall}{Precision + Recall} ,$$

which is e.g. based on the values “Precision” and “Recall” of the exemplary performance metrics of items c) and d) mentioned above.

In some embodiments at least one reference value that may be used for computing a performance metric according to some embodiments can be provided by use of a parametric model (i.e., a classic parametric model, whose parameters are determined based on configuration and/or signaling and/or measurement information, vs a machine learning model, whose parameters are iteratively adjusted following a supervised/unsupervised training or (self-) learning procedure, e.g. based on simulation and/or real-field data input to the machine learning model), which may e.g. run in parallel, and which may be used to solve the same problem as the machine learning based model.

In some embodiments, statistical quantities derivable from the abovementioned exemplary metrics may be also used, for example as model failure detection criteria, e.g. at least one of: a mean value, a standard deviation, a Q-tiles, a minimum value, a maximum value.

In some embodiments, a combination of relevant metrics, e.g. of the exemplary abovementioned metrics, and their usage, for example for a given machine learning model MLM, may be configured, for example depending on a traffic type. In some embodiments, the combination may be modified dynamically, e.g. during operation of the network device 10 and/or the terminal device, e.g. via MAC (medium access control)-level (e.g., layer 2) signaling.

In some embodiments, the information INF-TIM related to a temporal behavior for performance supervision of the at least one machine learning model MLM may characterize at least one of: periodic, aperiodic, semi-persistent.

In some embodiments, the information INF-FDP related to parameters for failure detection and/or rules for failure detection of the at least one machine learning model MLM may for example indicate one or more conditions that need to be fulfilled before a model failure is declared. In some embodiments, these conditions may include at least one of: a) a failure detection threshold for a given metric or thresholds for multiple metrics, b) an allowed number of failure instances, e.g. before the model failure will be declared, and c) an allowed time (for example a time to trigger) between the detection of a first failure instance and a model failure indication, which, in some embodiments, may e.g. be sent to higher layers.

In some embodiments, FIG. 3, the configuration information CFG-INF may be used, for example by the network device 10 and/or by the terminal device 20, for model supervision and/or failure detection, and optionally, for failure recovery, of the at least one machine learning model MLM.

In some embodiments, the at least one machine learning model MLM may be used for at least one of the following aspects: a) prediction, e.g. for predicting data associated with an operation of at least one of the first apparatus 100 (and/or the network device 10, respectively), the second apparatus 200 (and/or the terminal device 20, respectively), a further device (not shown, for example a further terminal device and/or a further network device), for example prediction of channel quality indicator(s), CQI, and/or channel state information, CSI, b) compression, e.g. for compressing data associated with an operation of at least one of the network device 10, the terminal device 20, a further device, for example CSI compression, and c) prediction, e.g. for predicting data associated with an operation of at least one of the first apparatus 100 (and/or the network device 10, respectively), the second apparatus 200 (and/or the terminal device 20, respectively), a further device (not shown, for example a further terminal device and/or a further network device), for example prediction for beam tracking, MCS selection, etc.

In some embodiments, FIG. 1, 4, the instructions 106, when executed by the at least one processor 102, cause the network device 10 to transmit 300 the configuration information CFG-INF in a radio resource control, RRC, message, for example within an RRC configuration message or an RRC reconfiguration message or an RRC UE assistance information message according to some accepted standard. As an example, in some embodiments, the network device 10 may use the configuration information CFG-INF to configure model failure detection resources, i.e. resources that may and/or should be used for a failure detection of the at least one machine learning model MLM, in the RRC message.

In some embodiments, the first apparatus 100 (or the network device 10, respectively) may configure the second apparatus 200 (or the terminal device 20, respectively) with one or more configurations, e.g. using the configuration information CFG-INF, e.g. transmitted via an RRC message, wherein at least one of the configurations may indicate a type or usage of the at least one machine learning model MLM (for example prediction, classification or compression model usage). In other words, in some embodiments, the configuration information CFG-INF may comprise information characterizing the type or usage of the at least one machine learning model MLM.

In some embodiments, the configuration information CFG-INF may also be used to indicate a specific format, for example specifying that learning is enabled for a given functionality, measurement or CSI quantity, and its corresponding parameters.

In some embodiments, FIG. 4, an operation of at least one of the second apparatus 200 (or the terminal device 20, respectively) and the machine learning model MLM may be controlled, see block 302, based on the configuration information CFG-INF.

In some embodiments, FIG. 7, the instructions 106, when executed by the at least one processor 102, cause the first apparatus 100 to at least temporarily perform at least one of: a) one or more operations 310 based on the at least one machine learning model MLM, for example processing or evaluating the machine learning model MLM (for example, inference), b) monitoring 311 a performance of the at least one machine learning model MLM, c) detecting 312 a failure of the at least one machine learning model MLM, d) indicating 313 a failure of the at least one machine learning model MLM, and e) initiating 314 a recovery of the at least one machine learning model MLM.

In some embodiments, the indicating 313 of a failure of the at least one machine learning model MLM may e.g. be performed using dynamic downlink or uplink or sidelink signaling.

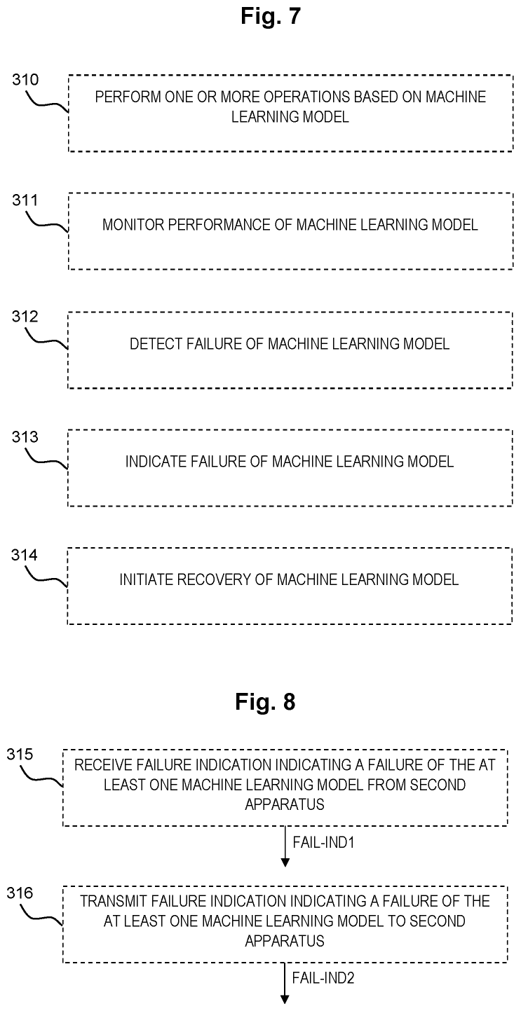

In some embodiments, FIG. 8, the instructions 106, when executed by the at least one processor 102, cause the first apparatus 100 to receive 315 a failure indication FAIL-IND1 indicating a failure of the at least one machine learning model MLM from the second apparatus 200.

In some embodiments, FIG. 8, the instructions 106, when executed by the at least one processor 102, cause the first apparatus 100 to transmit 316 a failure indication FAIL-IND2 indicating a failure of the at least one machine learning model MLM to the second apparatus 200. In some embodiments, this enables to notify a respective entity 100, 200 of a failure of the at least one machine learning model MLM.

In view of this, in some embodiments, signaling, for example for model failure detection and/or recovery, may depend on where the at least one machine learning model MLM is being applied and, for example, on which side, e.g. terminal device side or network device side, is initiating a model failure and/or recovery procedure. Some exemplary operational scenarios according to some embodiments will be explained further below.

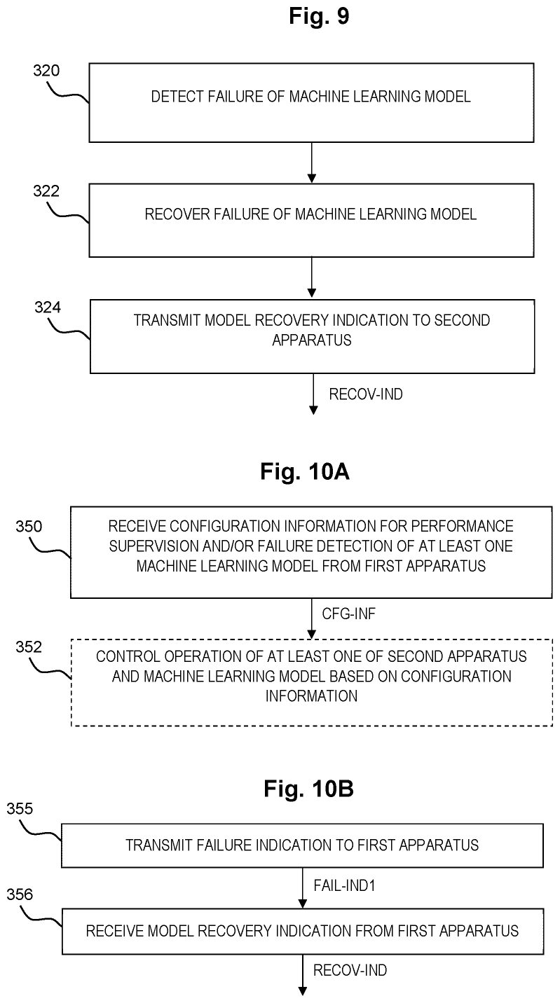

In some embodiments, FIG. 9, the instructions 106, when executed by the at least one processor 102, cause the first apparatus 100 to perform at least one of: a) detecting 320 a failure of the at least one machine learning model MLM, b) recovering 322 the failure of the at least one machine learning model MLM, c) transmitting 324 to the second apparatus 200 a model recovery indication RECOV-IND comprising at least one of: c1) an indication whether a failure recovery was successful, c2) at least one update of the machine learning model MLM, c3) configuration parameters associated with the failure recovery, c4) a time offset characterizing a start of operations based on a recovered model obtained by the failure recovery.

Some embodiments, FIG. 4, relate to a method comprising: transmitting 300, by a first apparatus 100, configuration information CFG-INF to a second apparatus 200 for performance supervision and/or failure detection of at least one machine learning model MLM, wherein the at least one machine learning model MLM is used by at least one of the first apparatus 100 and the second apparatus 200.

Some embodiments, see FIG. 3, 18, relate to a first apparatus 100′ comprising means 102′ for transmitting configuration information CFG-INF to a second apparatus 200, 200′ for performance supervision and/or failure detection of at least one machine learning model MLM, wherein the at least one machine learning model MLM is used by at least one of the first apparatus 100′ and the second apparatus 200, 200′. In some embodiments, the means 102′ for transmitting the configuration information CFG-INF may e.g. comprise at least one processor 102, and at least one memory 104 storing instructions 106, the at least one memory 104 and the instructions 106 configured to, with the at least one processor 102, perform the step of transmitting the configuration information CFG-INF.

Some embodiments, see FIG. 2, 3, 10A, relate to a second apparatus 200, comprising at least one processor 202, and at least one memory 204 storing instructions 206, the at least one memory 204 and the instructions 206 configured to, with the at least one processor 202, cause the second apparatus 200 to receive 350 (FIG. 10A) configuration information CFG-INF from a first apparatus 100, 100′ for performance supervision and/or failure detection of at least one machine learning model MLM, wherein the at least one machine learning model MLM is used by at least one of the first apparatus 100, 100′ and the second apparatus 200.

In some embodiments, the second apparatus 200 may be an apparatus for a wireless communications system 1 (FIG. 3).

In some embodiments, the second apparatus 200 or its functionality, respectively, may be provided in a terminal device 20, for example user equipment (UE), of the communications system 1. In some embodiments, the terminal device 20 may comprise at least one of: a) a smartphone, b) a tablet computer, c) a laptop or a personal computer, d) an IoT (Internet of Things) device, e) a wearable device such as e.g. a smart watch or virtual reality glasses, f) a vehicle, for example a car, a truck, an aircraft, for example an unmanned aerial vehicle, e.g. a drone.

In some embodiments, the second apparatus 200 according to the embodiments or its functionality, respectively, may be used for or within wireless communications systems 1, e.g. networks, based on or at least partially adhering to third generation partnership project, 3GPP, radio standards such as 5G (fifth generation), beyond 5G, e.g., 6G, or other radio access technology such as Wifi.

In some embodiments, an operation of at least one of the second apparatus 200 and the at least one machine learning model MLM may be controlled, see block 352 of FIG. 10A, based on the configuration information CFG-INF, i.e. the configuration information received from the first apparatus 100.

In some embodiments, the configuration information CFG-INF comprises at least one of the elements INF-RES, INF-SIG, INF-PM, INF-TIM, INF-FDP, and INF-FDR explained above with reference to FIG. 5.

In some embodiments, FIG. 10B, the at least one machine learning model MLM is used by the first apparatus 100, and the instructions 206, when executed by the at least one processor 202, cause the second apparatus 200 to transmit 355 a failure indication FAIL-IND1 to the first apparatus 100 indicative of a failure of the at least one machine learning model MLM detected in accordance with the configuration information, and to receive 356 a model recovery indication RECOV-IND from the first apparatus 100 responsive to the failure indication FAIL-IND1.

In some embodiments, the model recovery indication RECOV-IND comprises at least one of: a) an indication whether a failure recovery was successful, b) at least one update of the at least one machine learning model, c) configuration parameters associated with the failure recovery, and d) a time offset characterizing a start of operation based on a recovered model obtained by the failure recovery. In some embodiments, a) the first apparatus 100 is a base station and the second apparatus 200 is a terminal device, or b) the first apparatus 100 is a terminal device and the second apparatus 200 is a base station, or c) the first apparatus 100 is a terminal device and the second apparatus is a terminal device 100.

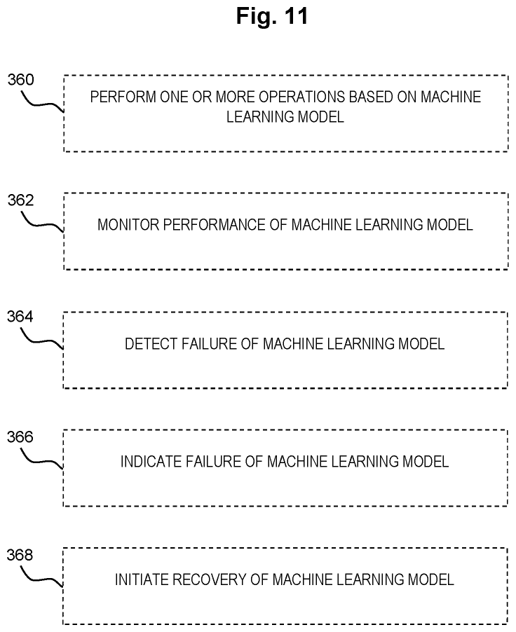

In some embodiments, FIG. 11, the instructions 206, when executed by the at least one processor 202, cause the second apparatus 200 to at least temporarily perform at least one of: a) one or more operations 360 based on the at least one machine learning model MLM, b) monitoring 362 a performance of the at least one machine learning model MLM, c) detecting 364 a failure of the at least one machine learning model MLM, d) indicating 366 a failure of the at least one machine learning model MLM, and e) initiating 368 a recovery of the at least one machine learning model MLM.

In some embodiments, indicating 366 a failure of the at least one machine learning model MLM may be performed using uplink (or sidelink) control information.

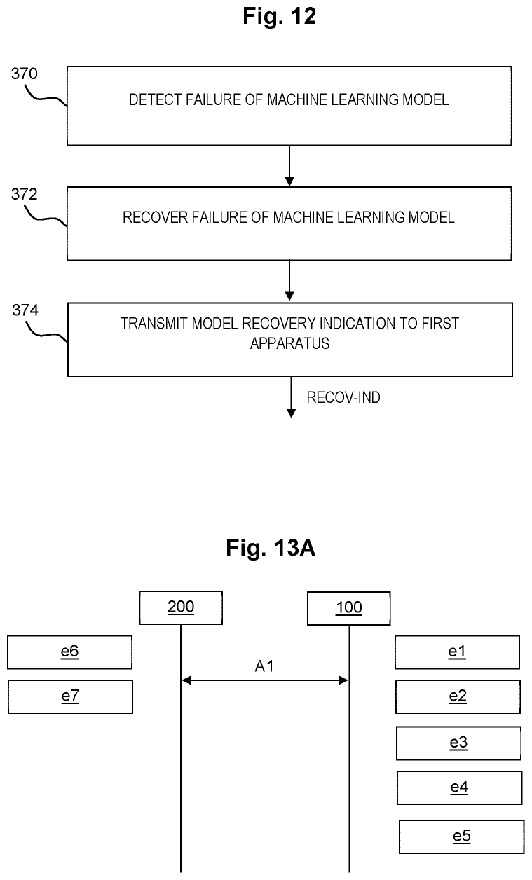

In some embodiments, FIG. 12, the instructions 206, when executed by the at least one processor 202, cause the second apparatus 200 to perform at least one of: a) detecting 370 a failure of the at least one machine learning model MLM, b) recovering 372 the failure of the at least one machine learning model MLM, and c) transmitting 374 to the first apparatus 100 a model recovery indication RECOV-IND comprising at least one of: c1) an indication whether a failure recovery 372 was successful (or failed, for example), c2) at least one update of the machine learning model MLM, c3) configuration parameters associated with the failure recovery 372, c4) a time offset characterizing a start of operations based on a recovered model obtained by the failure recovery 372.

In some embodiments, FIG. 3, the second apparatus 200 may transmit capability information CAP-INF, e.g. in the form of a capability report, e.g. to the first apparatus 100, the capability information CAP-INF characterizing a capability or a set of capabilities of the second apparatus 200 with respect to at least one machine learning model MLM. In some embodiments, for example, the second apparatus 200 or the associated terminal device 20 may indicate to the first apparatus 100 or the associated network device 10 that it is capable of applying and/or initializing and/or training one or more machine learning models MLM, for example for one or multiple features, e.g., CSI prediction, Col prediction, CSI compression, beam tracking, MCS selection, etc., using the capability information CAP-INF. In some embodiments, the capability information CAP-INF may form part of and/or may be comprised within the configuration information CFG-INF.

In some embodiments, at least one machine learning model MLM used at and/or by the second apparatus 200 (or its associated terminal device 20, respectively) may be defined by the second apparatus 200 or the terminal device 20. In some embodiments, at least one machine learning model MLM used at and/or by the second apparatus 200 (or its associated terminal device 20) may be initialized by the first apparatus 100 (or its associated network device 10). In some embodiments, at least one machine learning model MLM used at and/or by the second apparatus 200 or its associated terminal device 20 may be provided by the first apparatus 100, e.g. a network device associated with the first apparatus 100, for example by the network device 10.

In some embodiments, the second apparatus 200 or the terminal device 20 may apply a learned (i.e., trained) or received model MLM, for example in a supervised or unsupervised manner by the network. In other words, in some embodiments, the second apparatus 200 or terminal device 20 may use a machine learning model MLM which is trained via supervised learning, e.g. by the first apparatus 100 or the network device 10, whereas in some other embodiments, the second apparatus 200 or the terminal device 20 may use a machine learning model MLM which is trained via unsupervised learning.

Further embodiments, FIG. 10A, relate to a method comprising: receiving 350, by a second apparatus 200, configuration information CFG-INF from a first apparatus 100, 100′ for performance supervision and/or failure detection of at least one machine learning model MLM, wherein the at least one machine learning model MLM is used by at least one of the first apparatus 100, 100′ and the second apparatus 200.

Further embodiments, see FIG. 3, 19, relate to an apparatus 200′ comprising means 202′ for receiving configuration information CFG-INF from a first apparatus 100, 100′ for performance supervision and/or failure detection of at least one machine learning model MLM, wherein the at least one machine learning model MLM is used by at least one of the first apparatus 100, 100′ and the second apparatus 200′. In some embodiments, the means 202′ for receiving the configuration information CFG-INF may e.g. comprise at least one processor 202, and at least one memory 204 storing instructions 206, the at least one memory 204 and the instructions 206 configured to, with the at least one processor 202, perform the step of receiving the configuration information CFG-INF.

Further embodiments, FIG. 3, relate to a communications system 1 comprising at least one apparatus 100, 100′, 200, 200′ according to the embodiments.

Further embodiments, FIG. 1, 2, relate to a computer program comprising instructions 106, 206 which, when the program is executed by a computer 102, 202, cause the computer 102, 202 to carry out the method according to the embodiments.

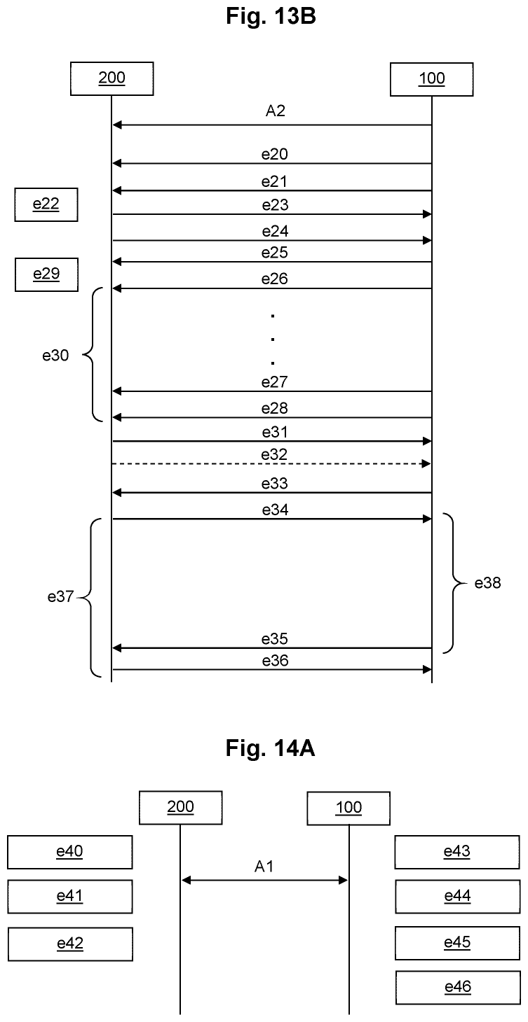

FIG. 13A schematically depicts a simplified block diagram according to some embodiments (“Variant 1”), wherein the double arrow A1 symbolizes an exemplary interface, for example air interface or other interface such as e.g. PC5 interface, over which data can be, for example wirelessly, exchanged between the first apparatus 100 and the second apparatus 200. In some embodiments, the first apparatus 100 of FIG. 13A may represent (or may be associated with) a network device such as a gNB or a terminal device such as a first UE. In some embodiments, the second apparatus 200 of FIG. 13A may represent (or may be associated with) a second terminal device such as a second UE.

Element e1 symbolizes performing one or more operations based on the at least one machine learning model MLM, which is at least temporarily carried out by the first apparatus 100. Element e2 symbolizes a “local” (as seen from the first apparatus 100) model performance supervision and failure detection function, which may also be implemented in the first apparatus 100 . . . . Element e3 symbolizes a model recovery function, which, according to FIG. 13A, may also at least temporarily be carried out by the first apparatus 100. Element e4 symbolizes a configuration function, which may at least temporarily be carried out by the first apparatus 100. Element e5 symbolizes model recovery information that may be used for recovery of the at least one machine learning model MLM, e.g. after detection of a failure of the at least one machine learning model MLM.

As can be seen from FIG. 13A, in the present embodiment, the model recovery function e3 is collocated with element e1, which performs the one or more operations based on the at least one machine learning model MLM.

Element e6 symbolizes a model failure reporting function which may at least temporarily be carried out by the second apparatus 200. Element e7 symbolizes a “remote” (as seen from the first apparatus 100) model performance supervision and failure detection function, which may be implemented in the second apparatus 200.

FIG. 13B schematically depicts a simplified signaling diagram according to some embodiments, wherein, for example, at least temporarily a configuration as exemplarily disclosed above with reference to FIG. 13A (Variant 1) may be used.

Arrow A2 symbolizes configuration information CFG-INF transmitted from the first apparatus 100 to the second apparatus 200, e.g. in form of an RRC Configuration or RRC Reconfiguration message. In some embodiments, the configuration information A2 may comprise at least one of: a) Model performance supervision resources or signal(s), b) a performance metric for the at least one machine learning model MLM, c) a performance supervision time behaviour for supervising the at least one machine learning model MLM, and d) model failure detection parameters and rules for the at least one machine learning model MLM.

Elements e20, e25, e27 exemplarily symbolize downlink control information or, if both apparatuses 100, 200 are assigned to respective UE, sidelink control information. Elements e22, e26, e28 exemplarily symbolize downlink (or sidelink) data and reference signals, element e23 exemplarily symbolizes uplink (or sidelink) control information, element e24 exemplarily symbolizes uplink (or sidelink) data and uplink (or sidelink) reference signals. Elements e22, e29 symbolize measuring a performance of the machine learning model MLM, e.g. associated with aspects of layer 1 (“L1”), element e30 symbolizes that the model performance drops below a model-specific threshold during a timer interval T_failure, which may e.g. be detected by element e7 of FIG. 13A, and element e31 of FIG. 13B symbolizes the second apparatus 200 transmitting a model failure indication to the first apparatus 100, e.g. using the model failure reporting function e6 of FIG. 13A.

Element e32 of FIG. 13B symbolizes an optional fallback indication which in some embodiments may be used by the second apparatus 200, e.g. to suggest a fallback solution, for example a temporary solution and/or initial values, to the first apparatus 100, for example until a model recovery of the at least one machine learning model MLM is finished.

Element e33 symbolizes a fallback confirmation and/or indication via which the first apparatus 100 may either confirm the optional suggestion e32 of the second apparatus 200 or indicate a new fallback solution to the second apparatus 200.

Element e34 symbolizes an optional model recovery assistance information, which in the present embodiment of FIG. 13B can be used to aid the first apparatus 100 with performing the recovery of the at least one machine learning model MLM.

Element e35 symbolizes a model recovery indication which may be used by the first apparatus 100 performing the one or more operations based on the at least one machine learning model MLM to indicate to the second apparatus 200 that the model recovery step is finalized. In some embodiments, the model recovery indication e35 may also contain a model based information update.

Element e36 symbolizes a model recovery confirmation via which the second apparatus 200 may confirm to the first apparatus 100 that the model recovery done by the first apparatus 100 results in a satisfactory performance.

Element e37 symbolizes a delay before returning to model-based operations on the side of the second apparatus 200, and element e38 symbolizes a corresponding model update and/or test and/or warmup period enabling a re-establishment of an operation of the at least one machine learning model MLM at the first apparatus 100.

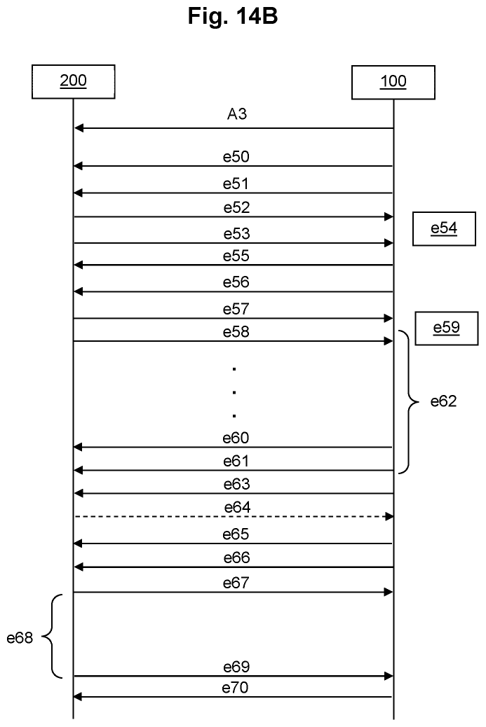

FIG. 14A schematically depicts a simplified block diagram according to some embodiments (“Variant 2”), wherein the double arrow A1 symbolizes an exemplary interface, for example air interface or other interface such as e.g. PC5 interface, over which data can be, for example wirelessly, exchanged between the first apparatus 100 and the second apparatus 200. In some embodiments, the first apparatus 100 of FIG. 14A may represent (or may be associated with) a network device such as a gNB or a terminal device such as a first UE. In some embodiments, the second apparatus 200 of FIG. 14A may represent (or may be associated with) a second terminal device such as a second UE.

Element e40 symbolizes performing one or more operations based on the at least one machine learning model MLM, which is at least temporarily carried out by the second apparatus 200. Element e41 symbolizes a “local” (as seen from the second apparatus 200) model performance supervision and failure detection function, which may also be implemented in the second apparatus 200. Element e42 symbolizes a model recovery function, which, according to FIG. 14A, may also at least temporarily be carried out by the second apparatus 200.

Element e43 symbolizes a model failure reporting function which may at least temporarily be carried out by the first apparatus 100. Element e44 symbolizes a “remote” (as seen from the second apparatus 200) model performance supervision and failure detection function, which may be implemented in the first apparatus 100. Element e45 symbolizes a configuration function, which may at least temporarily be carried out by the first apparatus 100. Element e46 symbolizes model recovery assistance information that may be used for assisting the second apparatus 200, e.g. the model recovery function e42 of the second apparatus 200, with a recovery of the at least one machine learning model MLM, e.g. after detection of a failure of the at least one machine learning model MLM.

FIG. 14B schematically depicts a simplified signaling diagram according to some embodiments, wherein, for example, at least temporarily a configuration as exemplarily disclosed above with reference to FIG. 14A (Variant 2) may be used.

Arrow A3 symbolizes configuration information CFG-INF transmitted from the first apparatus 100 to the second apparatus 200, e.g. in form of an RRC Configuration or RRC Reconfiguration message. In some embodiments, the configuration information A3 may comprise at least one of: a) Model performance supervision resources or signal(s), b) a performance metric for the at least one machine learning model MLM, c) a performance supervision time behaviour for supervising the at least one machine learning model MLM, and d) model failure detection parameters and rules for the at least one machine learning model MLM.

Elements e50, e54, e60 exemplarily symbolize downlink (or sidelink) control information. Elements e51, e56, e61 exemplarily symbolize downlink (or sidelink) data and reference signals, elements e52, e57 exemplarily symbolize uplink (or sidelink) control information, elements e53, e58 exemplarily symbolize uplink (or sidelink) data and uplink (or sidelink) reference signals. Elements e54, e59 symbolize measuring a performance of the machine learning model MLM, e.g. associated with aspects of layer 1 (“L1”), element e62 symbolizes that the model performance drops below a model-specific threshold during a timer interval T_failure, which may e.g. be detected by element e44 of FIG. 14B, and element e63 of FIG. 14B symbolizes the first apparatus 100 transmitting a model failure indication to the second apparatus 200, e.g. using the model failure reporting function e43 of FIG. 14A.

Element e64 of FIG. 14B symbolizes an optional fallback indication which in some embodiments may be used by the second apparatus 200, e.g. to suggest a fallback solution, for example a temporary solution, to the first apparatus 100, for example until a model recovery of the at least one machine learning model MLM is finished.

Element e65 symbolizes a fallback confirmation and/or indication via which the first apparatus 100 may either confirm the optional suggestion e64 of the second apparatus 200 or indicate a new fallback solution to the second apparatus 200.

Element e66 symbolizes an optional model recovery assistance information, which in the present embodiment of FIG. 14B can be used to aid the second apparatus 200 with performing the recovery of the at least one machine learning model MLM.

In some embodiments, the second apparatus 200 may ask (not shown) the first apparatus 100 for more model recovery information. In some embodiments, the second apparatus 200 may transmit a model recovery indication confirmation e67 to signal that the second apparatus 200 does not need more model recovery information from the first apparatus 100.

Element e69 symbolizes a model recovery indication which may be used by the second apparatus 200 performing the one or more operations based on the at least one machine learning model MLM to indicate to the first apparatus 100 that the model recovery step is finalized. In some embodiments, the model recovery indication e69 may also contain a model based information update.

Element e70 symbolizes a model recovery confirmation via which the first apparatus 100 may confirm to the second apparatus 200 that the model recovery done by the second apparatus 200 results in a satisfactory performance.

Element e68 symbolizes a model update and/or test and/or warmup period enabling a re-establishment of an operation of the at least one machine learning model MLM at the second apparatus 200.

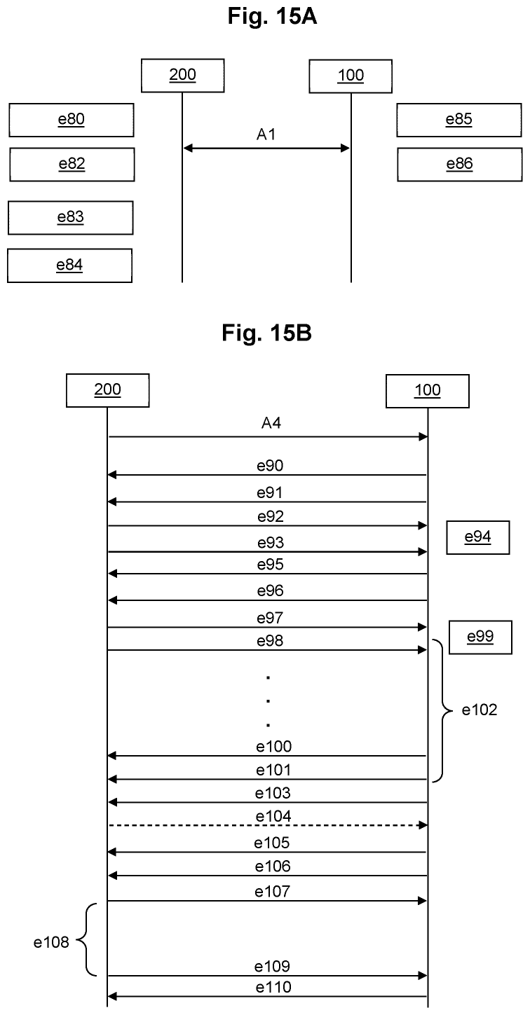

FIG. 15A schematically depicts a simplified block diagram according to some embodiments (“Variant 2B”), wherein the double arrow A1 symbolizes an exemplary interface, for example air interface or other interface such as e.g. PC5 interface, over which data can be, for example wirelessly, exchanged between the first apparatus 100 and the second apparatus 200. In some embodiments, the first apparatus 100 of FIG. 15A may represent (or may be associated with) a network device such as a gNB or a terminal device such as a first UE. In some embodiments, the second apparatus 200 of FIG. 15A may represent (or may be associated with) a second terminal device such as a second UE.

Element e80 symbolizes performing one or more operations based on the at least one machine learning model MLM, which is at least temporarily carried out by the second apparatus 200. Element e81 symbolizes a “local” (as seen from the second apparatus 200) model performance supervision and failure detection function, which may also be implemented in the second apparatus 200. Element e83 symbolizes a model recovery function, which, according to FIG. 15A, may also at least temporarily be carried out by the second apparatus 200. Element e84 symbolizes a configuration function, which may at least temporarily be carried out by the second apparatus 200.

Element e85 symbolizes a model failure reporting function which may at least temporarily be carried out by the first apparatus 100. Element e86 symbolizes a “remote” (as seen from the second apparatus 200) model performance supervision and failure detection function, which may be implemented in the first apparatus 100.

FIG. 15B schematically depicts a simplified signaling diagram according to some embodiments, wherein, for example, at least temporarily a configuration as exemplarily disclosed above with reference to FIG. 15A (Variant 2B) may be used.

Arrow A4 symbolizes assistance information transmitted from the second apparatus 200 to the first apparatus 100, e.g. in form of an RRC message, for instance RRC UE assistance information message. In some embodiments, the assistance information A4 may comprise at least one of: a) Model performance supervision resources or signal(s), b) a performance metric for the at least one machine learning model MLM, c) a performance supervision time behaviour for supervising the at least one machine learning model MLM, and d) model failure detection parameters and rules for the at least one machine learning model MLM.

In some embodiments, configuration information (not shown in FIG. 15B, see for example arrow A3 of FIG. 14A) may be transmitted from the first apparatus 100 to the second apparatus 200, for example prior to and/or after receiving the assistance information A4.

Elements e90, e95, e100 exemplarily symbolize downlink (or sidelink) control information. Elements e91, e96, e101 exemplarily symbolize downlink (or sidelink) data and reference signals, elements e92, e97 exemplarily symbolize uplink (or sidelink) control information, elements e93, e98 exemplarily symbolize uplink (or sidelink) data and uplink (or sidelink) reference signals. Elements e94, e99 symbolize measuring a performance of the machine learning model MLM, e.g. associated with aspects of layer 1 (“L1”), element e102 symbolizes that the model performance drops below a model-specific threshold during a timer interval T_failure, and element e103 of FIG. 15B symbolizes the first apparatus 100 transmitting a model failure indication to the second apparatus 200, e.g. using the model failure reporting function e85 of FIG. 15A.

Element e104 of FIG. 15B symbolizes an optional fallback indication which in some embodiments may be used by the second apparatus 200, e.g. to suggest a fallback solution, for example a temporary solution, to the first apparatus 100, for example until a model recovery of the at least one machine learning model MLM is finished.

Element e105 symbolizes a fallback confirmation and/or indication via which the first apparatus 100 may either confirm the optional suggestion e104 of the second apparatus 200 or indicate a new fallback solution to the second apparatus 200.

Element e106 symbolizes an optional model recovery assistance information, which in the present embodiment of FIG. 15B can be used to aid the second apparatus 200 with performing the recovery of the at least one machine learning model MLM.

In some embodiments, the second apparatus 200 may transmit a model recovery indication confirmation e107 to the first apparatus 100 to signal that the second apparatus 200 does not need more model recovery information from the first apparatus 100.

Element e109 symbolizes a model recovery indication which may be used by the second apparatus 200 performing the one or more operations based on the at least one machine learning model MLM to indicate to the first apparatus 100 that the model recovery step is finalized. In some embodiments, the model recovery indication e109 may also contain a model based information update.

Element e110 symbolizes a model recovery confirmation via which the first apparatus 100 may confirm to the second apparatus 200 that the model recovery done by the second apparatus 200 results in a satisfactory performance.

Element e108 symbolizes a model update and/or test and/or warmup period enabling a re-establishment of an operation of the at least one machine learning model MLM at the second apparatus 200.

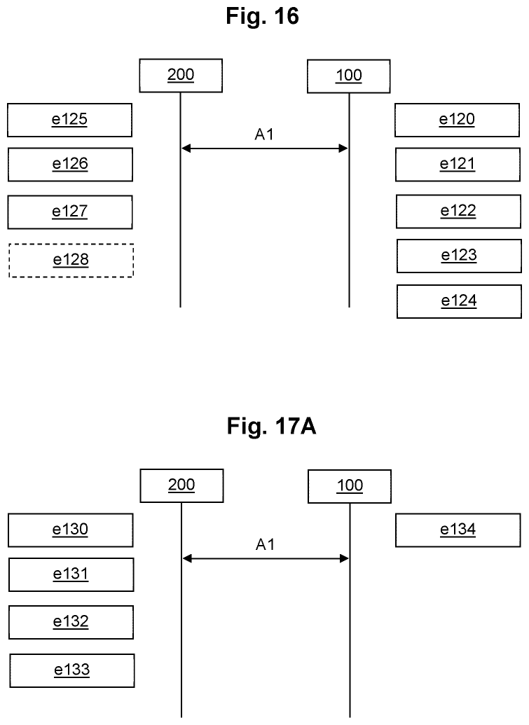

FIG. 16A schematically depicts a simplified block diagram according to some embodiments (“Variant 3”), wherein the double arrow A1 symbolizes an exemplary interface, for example air interface or other interface such as e.g. PC5 interface, over which data can be, for example wirelessly, exchanged between the first apparatus 100 and the second apparatus 200. In some embodiments, the first apparatus 100 of FIG. 16A may represent (or may be associated with) a network device such as a gNB or a terminal device such as a first UE. In some embodiments, the second apparatus 200 of FIG. 16A may represent (or may be associated with) a second terminal device such as a second UE or a (second) network device such as a second gNB.

Element e120 symbolizes performing one or more operations based on the at least one machine learning model MLM, which is at least temporarily carried out by the first apparatus 100.

Element e121 symbolizes a model failure reporting function which may at least temporarily be carried out by the first apparatus 100.

Element e122 symbolizes a “remote and/or local” (e.g., as seen from the first apparatus 100) model performance supervision and failure detection function, which is implemented in the first apparatus 100. Element e123 symbolizes a model recovery function, which, according to FIG. 16A, may also at least temporarily be carried out by the first apparatus 100. Element e124 symbolizes a configuration function, which may at least temporarily be carried out by the first apparatus 100.

Element e125 symbolizes performing one or more operations based on the at least one machine learning model MLM, which is at least temporarily carried out by the second apparatus 200. In other words, in the present exemplary embodiment of FIG. 16A, model based operations are carried out in both the first apparatus 100 and the second apparatus 200.

Element e126 symbolizes a “remote and/or local” (e.g., as seen from the second apparatus 200) model performance supervision and failure detection function, which is implemented in the second apparatus 200, similar to element e122 of the first apparatus 100. Element e127 symbolizes a model recovery function, which, according to FIG. 16A, may also at least temporarily be carried out by the second apparatus 200.

In some embodiments, optionally, the second apparatus 200 may comprise a configuration function e128, e.g. similar to element e124 of the first apparatus, which characterizes a further exemplary variant (“Variant 3B”).

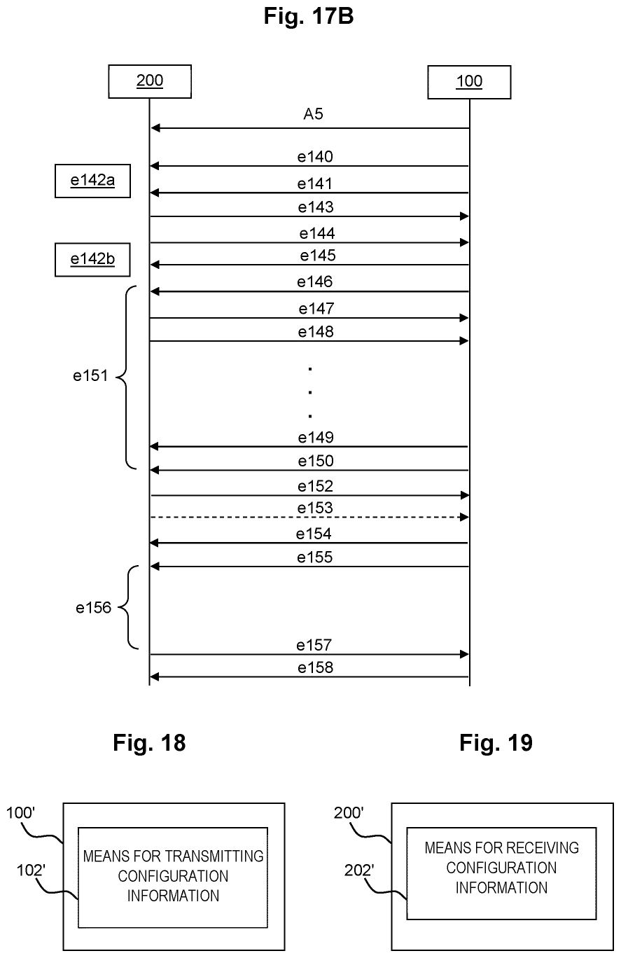

FIG. 17A schematically depicts a simplified block diagram according to some embodiments (“Variant 5”), wherein the double arrow A1 symbolizes an exemplary interface, for example air interface or other interface such as e.g. PC5 interface, over which data can be, for example wirelessly, exchanged between the first apparatus 100 and the second apparatus 200. In some embodiments, the first apparatus 100 of FIG. 17A may represent (or may be associated with) a network device such as a gNB or a terminal device such as a first UE. In some embodiments, the second apparatus 200 of FIG. 17A may represent (or may be associated with) a second terminal device such as a second UE.

Element e130 symbolizes performing one or more operations based on the at least one machine learning model MLM, which is at least temporarily carried out by the second apparatus 200. Element e131 symbolizes a model failure reporting function which may at least temporarily be carried out by the second apparatus 200. Element e132 symbolizes a “local” (e.g., as seen from the second apparatus 200) model performance supervision and failure detection function, which is implemented in the second apparatus 200. Element e133 symbolizes a model recovery function, which, according to FIG. 17A, may also at least temporarily be carried out by the second apparatus 200.

Element e134 symbolizes a configuration function, which may at least temporarily be carried out by the first apparatus 100.

FIG. 17B schematically depicts a simplified signaling diagram according to some embodiments, wherein, for example, at least temporarily a configuration as exemplarily disclosed above with reference to FIG. 17A (Variant 5) may be used.

Arrow A5 symbolizes configuration information CFG-INF transmitted from the first apparatus 100 to the second apparatus 200, e.g. in form of an RRC Configuration or RRC Reconfiguration message. In some embodiments, the configuration information A5 may comprise at least one of: a) Model performance supervision resources or signal(s), b) a performance metric for the at least one machine learning model MLM, c) a performance supervision time behaviour for supervising the at least one machine learning model MLM, and d) model failure detection parameters and rules for the at least one machine learning model MLM.

Elements e140, e145, e149 exemplarily symbolize downlink (or sidelink) control information. Elements e141, e146, e150 exemplarily symbolize downlink (or sidelink) data and reference signals, elements e143, e147 exemplarily symbolize uplink (or sidelink) control information, elements e144, e148 exemplarily symbolize uplink (or sidelink) data and uplink (or sidelink) reference signals. Elements e142a, e142b symbolize measuring a performance of the machine learning model MLM, e.g. associated with aspects of layer 1 (“L1”), element e151 symbolizes that the model performance drops below a model-specific threshold during a timer interval T_failure, and element e152 of FIG. 17B symbolizes the second apparatus 200 transmitting a model failure indication to the first apparatus 100, e.g. using the model failure reporting function e131 of FIG. 17A.

Element e153 of FIG. 17B symbolizes an optional fallback indication which in some embodiments may be used by the first apparatus 100, e.g. to suggest a fallback solution, for example a temporary solution, to the second apparatus 200, for example until a model recovery of the at least one machine learning model MLM is finished.

Element e154 symbolizes a fallback confirmation and/or indication via which the first apparatus 100 may either confirm the optional suggestion e153 of the second apparatus 200 or indicate a new fallback solution to the second apparatus 200.

Element e155 symbolizes an optional model recovery assistance information, which in the present embodiment of FIG. 17B can be used to aid the second apparatus 200 with performing the recovery of the at least one machine learning model MLM.

Element e156 symbolizes a model update and/or test and/or warmup period enabling a re-establishment of an operation of the at least one machine learning model MLM at the second apparatus 200.

Element e157 symbolizes a model recovery indication which may be used by the second apparatus 200 to indicate to the first apparatus 100 that the model recovery step is finalized. In some embodiments, the model recovery indication e157 may also contain a model based information update.

Element e158 symbolizes a model recovery confirmation via which the first apparatus 100 may confirm to the second apparatus 200 that the model recovery done by the second apparatus 200 results in a satisfactory performance.

In some embodiments, Variants 3, 3B explained above with reference to FIG. 16 relate to exemplary embodiments, where one or more machine learning models MLM are deployed at both sides, e.g. at the first apparatus 100 and at the second apparatus 200, wherein the one or more machine learning models MLM may e.g. comprise at least one of: an encoder-decoder model, and an actor-critic reinforcement learning model(s).

In some embodiments, e.g. related to Variants 3, 3B according to FIG. 16, at least one of training, inference, model supervision and model failure detection can be performed at either or both sides, i.e., at the first apparatus 100 and/or at the second apparatus 200, e.g. depending on a configuration and/or on allocated resources, e.g. for training, e.g. over the interface A1.

Although in some embodiments, machine learning-based models may be deployed at both sides or ends of the link A1, i.e., first apparatus 100 and second apparatus 200, in some embodiments, the network 1 or network device 10 or the first apparatus 100 or the second apparatus 200 may choose a configuration in which, at least temporarily, only the first apparatus 100 or the second apparatus 200 performs e.g. model performance monitoring and/or failure detection.

Alternately, in some embodiments, model performance supervision or monitoring and/or failure detection may be performed by both the first apparatus 100 and the second apparatus 200, for example either with respect to some or all the model components of the at least one machine learning model, at both ends 100, 200, or, in some embodiments, with respect to e.g. a single component of the at least one machine learning model, e.g. at one end 100, 200 of the link A1.

For example, for an actor-critic reinforcement learning approach, in some embodiments, performance monitoring and/or failure detection of the critic and/or actor models may be performed at the first apparatus 100, at the second apparatus 200 or at both the first apparatus 100 and the second apparatus 200.

Note that placement of functionalities, e.g. in Variants 3, 3B can, in some embodiments, be quite flexible, wherein e.g. model performance supervision or monitoring and failure detection may be placed at one or either ends of the link A1.

In some embodiments (“Variant 4”), the processes related e.g. to the elements e120 to e128 of FIG. 16, may be carried out, for example only, by one of the first apparatus 100 and the second apparatus 200.

In some embodiments, FIG. 3, e.g. upon detection of a model failure of the at least one machine learning model MLM, e.g. at the first apparatus 100 or at the second apparatus 200, signaling may be exchanged between the components 100, 200, e.g. in order to perform at least one of: declaring a model failure, exchanging recovery information, indicating a fallback, e.g. to a default operations mode, indicating acknowledgement (ACK) or negative ACK (NACK) for model recovery information, indicating recovery failure or success, among others.

In some embodiments, the signaling depends on the considered variant, i.e. where the at least one machine learning model MLM is deployed (e.g., at the first apparatus 100 or at the second apparatus 200 or at both components 100, 200) and, for example, on which entity 100, 200 performs model performance supervision and failure detection.

In some embodiments, the content of the model recovery information depends on several considerations, e.g. including at least one of: the used learning methods, the availability of alternative models or configured fallback default operation.

In some embodiments, conditions that need to be met before a model failure recovery is initiated may be multiple and may e.g. depend on a traffic type (e.g., different conditions for URLLC (ultra reliable low latency) and eMBB (enhance mobile broadband) traffic), mobility parameters, e.g. UE velocity, propagation environment.

In the following, some model failure conditions according to further exemplary embodiments are listed:
a) Evaluated performance of the machine learning model MLM, e.g. based on measurements on model failure detection resources, drop below a given threshold for a given number of measured instances, or during the duration of a given timer, or at the expiration of a given timer.
b) The thresholds in question may be applicable to at least one of: instantaneous value(s) of the measurement, filtered measurements, measurements statistics (e.g., Q-tiles, standard deviation value, mean value, minimum value, maximum value).
c) Model failure detection can also rely on other exchanged information, e.g. HARQ-ACK and/or CSI quantities or the like.

For example, in some embodiments, one criterion for model failure detection may be that the minimum precision of a given model dropped below a configured threshold for/after a given time interval.

In the following, further aspects and details of model failure recovery according to exemplary embodiments are provided.

In some embodiments, once a failure of a machine learning model, e.g. associated with at least one aspect of a radio access network (RAN), is detected, depending on the considered variant (for example, at least one of the Variants 1, 2, 2B, 3, 3A, 5 exemplarily described above), at least one of the first apparatus 100 or the second apparatus 200 may transmit model recovery information.

In some embodiments, the model recovery information, e.g. at least one message carrying the model recovery information, may comprise information to update and/or reset the failing machine learning model. In some embodiments, depending on which variant and functionality the machine learning model MLM is supporting, the recovery information may include one or multiple of the following: a) fallback configuration indication, b) new model parameters initialization, c) last valid model version/timestamp, d) model recovery ACK criterion (target performance for the new model to be considered as valid), e) test data set.

In the following, further aspects and details of fallback options according to exemplary embodiments are provided.

In some embodiments, in case a model failure occurs, it may be beneficial to provide a fallback operation mode which can be used while model recovery is performed, e.g. instead of the (failed) machine learning model. In some embodiments, the fallback model may be also based on at least one machine learning model. In some embodiments, a valid fallback mode for a given machine learning model-based operation, e.g. CSI quantity, is indicated in an RRC configuration. In some embodiments, a fallback configuration indication may be conveyed in the recovery information, e.g. to select one out of multiple configured fallback options.

In some embodiments, the fallback options may be one of the following: a) default fallback model, b) previous model version(s), c) default operation mode (e.g., conventional operations, for example conventional New Radio operations), e.g. without machine learning model-based operations.

In the following, further aspects and details of signaling between the first apparatus 100 and the second apparatus 200 are provided.

With reference to FIG. 13A to 17E, several exemplary variants 1, 2, 2B, 3, 3A according to some exemplary embodiments have been explained, e.g. for cases where at least one machine learning model MLM is running at the first apparatus 100 and/or at the second apparatus 200. In the following, further exemplary aspects of signaling between the first apparatus 100 and the second apparatus 200 are disclosed.

Note that in some embodiments, e.g. according to FIG. 13A, 14A, at least some steps of model failure detection and/or recovery may be carried out, for example only, at one side, e.g. by the first apparatus 100 or by the second apparatus 200, see for example elements e41, e42 of FIG. 14A. Even though these steps may be mainly handled by one apparatus 100, 200, in some embodiments, different methods of using machine learning based models (e.g. auto-encoder model, independent model), e.g. at different nodes or devices 100, 200, may be supported.

In some embodiments, see for example FIG. 17A, the machine learning model (see element e130) may, for example only, be used at a same side 200 that also carries out aspects or steps of model failure detection e132 and model recovery e133.

In some embodiments, the machine learning model may, for example, be used by a different side or device than the side or device that handles model failure detection and/or model recovery.

In some embodiments, for example for at least one of the variants 1 to 5, assistance information from the side that is not, for example fully, involved in the model failure detection and recovery, may be provided, e.g. via an extra signaling exchange, which can e.g. be used to assist the other device in the process of model recovery, see for example the model recovery assistance information e66 of FIG. 14B.

In some embodiments, where one side (first apparatus 100 or second apparatus 200) is declaring a failure, in a next step the other side (second apparatus 200 or first apparatus 100) can confirm a fallback solution, e.g. via a fallback ACK, see for example the fallback confirmation e65 of FIG. 14B.

In some embodiments, the principle according to the embodiments may e.g. be used to detect and/or correct failures of the at least one machine learning model MLM (FIG. 3), which, in some embodiments may e.g. be used for processing data e.g. associated with a physical layer. In some embodiments, a robustness of the system 1 and/or an operation of the machine learning model MLM may be improved using the principle according to the embodiments, e.g. enabling thus to use traffic types such as URLLC and XR (extreme reality). In some embodiments, a comprehensive model failure and recovery framework may be provided that enables fast correction e.g. of drifts and/or model obsoleteness, e.g. at the UE 20 and/or the RAN, e.g. gNB 10.

1-16. (canceled)

17. A first apparatus comprising at least one processor, and at least one memory storing instructions, the at least one memory and the instructions configured to, with the at least one processor, cause the first apparatus to:
transmit configuration information to a second apparatus for performance supervision and/or failure detection of at least one machine learning model,
wherein the at least one machine learning model is used by at least one of the first apparatus and the second apparatus.

18. The first apparatus according to claim 17, wherein the configuration
information comprises at least one of:
information related to at least one resource for performance supervision of the at least one machine learning model;
information related to at least one signal for performance supervision of the at least one machine learning model;
information related to at least one performance metric for failure detection of the at least one machine learning model;
information related to a temporal behavior for performance supervision and/or failure detection of the at least one machine learning model;
information related to parameters for failure detection of the at least one machine learning model; or
information related to rules for failure detection of the at least one machine learning model.

19. The first apparatus according to claim 18, wherein the information related to at least one resource for performance supervision of the at least one machine learning model and/or the information related to at least one signal for performance supervision of the at least one machine learning model characterizes at least one of:
a downlink reference signal;
a dedicated signal; or
a resource element associated with a data signal.

20. The first apparatus according to claim 18, wherein the information related to at least one performance metric for failure detection of the at least one machine learning model characterizes at least one of:
a mean square error of a variable output by the least one machine learning model;
a mean absolute error of a variable output by the least one machine learning model;
a recall;
a precision;
an accuracy; or
an F1-score.

21. The first apparatus according to claim 17, wherein the at least one machine learning model is used by the first apparatus, and wherein the instructions, when executed by the at least one processor, cause the first apparatus to:
receive a failure indication from the second apparatus indicative of a failure of the at least one machine learning model detected in accordance with the configuration information; and
responsive to the failure indication, transmit a model recovery indication to the second apparatus.

22. The first apparatus according to claim 21, wherein the failure indication comprises a fallback solution for recovering the failure of the at least one machine learning model.

23. The first apparatus according to claim 21, wherein the model recovery indication comprises at least one of:
an indication whether a failure recovery was successful;
at least one update of the at least one machine learning model;
configuration parameters associated with the failure recovery; or
a time offset characterizing a start of operation based on a recovered model obtained by the failure recovery.

24. The first apparatus according to claim 17, wherein:
the first apparatus is a base station and the second apparatus is a terminal device, or
the first apparatus is a terminal device and the second apparatus is a base station, or
the first apparatus is a terminal device and the second apparatus is a terminal device.

25. A method comprising:
transmitting, by a first apparatus, configuration information to a second apparatus for performance supervision and/or failure detection of at least one machine learning model,
wherein the at least one machine learning model is used by at least one of the first apparatus and the second apparatus.

26. The method according to claim 25, wherein the configuration information comprises at least one of:
information related to at least one resource for performance supervision of the at least one machine learning model;
information related to at least one signal for performance supervision of the at least one machine learning model;
information related to at least one performance metric for failure detection of the at least one machine learning model;
information related to a temporal behavior for performance supervision and/or failure detection of the at least one machine learning model;
information related to parameters for failure detection of the at least one machine learning model; or
information related to rules for failure detection of the at least one machine learning model.

27. The method according to claim 26, wherein the information related to at least one resource for performance supervision of the at least one machine learning model and/or the information related to at least one signal for performance supervision of the at least one machine learning model characterizes at least one of:
a downlink reference signal;
a dedicated signal; or
a resource element associated with a data signal.

28. The method according to claim 26, wherein the information related to at least one performance metric for failure detection of the at least one machine learning model characterizes at least one of:
a mean square error of a variable output by the least one machine learning model;
a mean absolute error of a variable output by the least one machine learning model;
a recall;
a precision;
an accuracy; or
an F1-score.

29. The method according to claim 25, wherein the at least one machine learning model is used by the first apparatus, and wherein the instructions, when executed by the at least one processor, cause the first apparatus to:
receive a failure indication from the second apparatus indicative of a failure of the at least one machine learning model detected in accordance with the configuration information; and
responsive to the failure indication, transmit a model recovery indication to the second apparatus.

30. The method according to claim 29, wherein the failure indication comprises a fallback solution for recovering the failure of the at least one machine learning model.

31. A second apparatus comprising at least one processor, and at least one memory storing instructions, the at least one memory and the instructions configured to, with the at least one processor, cause the second apparatus to:
receive configuration information from a first apparatus for performance supervision and/or failure detection of at least one machine learning model,
wherein the at least one machine learning model is used by at least one of the first apparatus and the second apparatus.

32. The second apparatus according to claim 31, wherein the configuration information comprises at least one of:
information related to at least one resource for performance supervision of the at least one machine learning model;
information related to at least one signal for performance supervision of the at least one machine learning model;
information related to at least one performance metric for failure detection of the at least one machine learning model;
information related to a temporal behavior for performance supervision and/or failure detection of the at least one machine learning model;
information related to parameters for failure detection of the at least one machine learning model; or
information related to rules for failure detection of the at least one machine learning model.

33. The second apparatus according to claim 31, wherein the at least one machine learning model is used by the first apparatus, and wherein the instructions, when executed by the at least one processor, cause the second apparatus to:
transmit a failure indication indicative of a failure of the at least one machine learning model detected in accordance with the configuration information to the first apparatus; and
receive a model recovery indication from the first apparatus responsive to the failure indication.

34. The second apparatus according to claim 33, wherein the failure indication comprises a fallback solution for recovering the failure of the at least one machine learning model.

35. The second apparatus according to claim 33, wherein the model recovery indication comprises at least one of:
an indication whether a failure recovery was successful;
at least one update of the at least one machine learning model;
configuration parameters associated with the failure recovery; or
a time offset characterizing a start of operation based on a recovered model obtained by the failure recovery.

36. The second apparatus according to claim 31, wherein:
the first apparatus is a base station and the second apparatus is a terminal device, or
the first apparatus is a terminal device and the second apparatus is a base station, or
the first apparatus is a terminal device and the second apparatus is a terminal device.
